(19) United States
(12) Patent Application Publication
(10) Pub. No.: US 2024/0015250 A1
(43) Pub. Date: Jan. 11, 2024

(54) METHOD AND APPARATUS FOR PROVIDING A PRE-PAID SERVICE IN A CELLULAR COMMUNICATION NETWORK

(71) Applicant: Telefonaktiebolaget LM Ericsson (publ), Stockholm (SE)

(72) Inventors: Jingrui TAO, Guangzhou (CN); Ping CHEN, Shanghai (CN); Qiang LIU, Shanghai (CN); Emiliano Merino VAZQUEZ, Madrid (ES); Susana FERNANDEZ ALONSO, Madrid (ES)

(21) Appl. No.: 18/255,708

(22) PCT Filed: Dec. 6, 2021
(86) PCT No.: PCT/CN2021/135600

§ 371 Date: Jun. 2, 2023

(30) Foreign Application Priority Data
Dec. 7, 2020 (WO) PCT/CN2020/134343

(51) Int. Cl. H04M 17/00; H04M 15/00

(52) U.S. Cl. CPC H04M 17/00; H04M 15/66; H04M 15/8016

(57) ABSTRACT

The present disclosure generally relates to wireless communication technology. More particularly, the present disclosure relates to a method for providing a pre-paid service in a cellular communication network. The present disclosure also relates to apparatus and computer program product adapted for the same purpose. According to one embodiment, a method for providing a pre-paid service in a cellular communication network includes the following steps carried out at a first node: sending to a second node a request for subscribing to an event where resources for one of a group of subscribers have run out; and in response to a message on occurrence of the event from the second node, sending to a terminal device using the resources a notification that the resources have run out, wherein the first node is a node for application function (AF), and the second node is a node for exposing network capabilities and events.

### TECHNICAL FIELD

The present disclosure generally relates to wireless communication technology. More particularly, the present disclosure relates to a method for providing a pre-paid service in a cellular communication network. The present disclosure also relates to apparatus and computer program product adapted for the same purpose.

### BACKGROUND

3GPP network allows Application Functions (e.g. for untrusted AFs via an Exposure Function like SCEF/NEF) to receive notifications on bearer level events (e.g. release of bearer) when the AF creates an AF session with a specific quality of service (QoS) level.

An AF can specify a required QoS reference to be applied to a given UE for a given IP flow, e.g. AF from Sony may indicate (via NEF/SCEF) that a given UE using Sony Play Store Online is allocated to a QoS for IP flow. To complete the configuration on QoS, the 3GPP network shall notify Sony's AF about the bearer for the flow being released, or the IP connectivity (PDN connection) for the UE being dropped.

In other words, an AF can define a specific QoS level for a given IP flow to/from one UE and receive events associated with the bearer on which the IP flow is installed.

FIG. 1 schematically illustrates a typical QoS control procedure in a scenario where a pre-paid service is provided by an AF.

As shown in FIG. 1, the procedure comprises the following steps:

Step S101: AF node initiates an AF session with a QoS request includes a UE IP address, an IP flow ID, and a QoS reference applied to the UE IP address and the IP flow.

Step S102: In response to the QoS request, SCEF node initiates an Rx session with PCRF/PCF node by sending a Rx Authentication Request or creates a resource for the Npcf_PolicyAuthorization service in the PCF Network Function including App ID mapped from the QoS reference received from AF node, the UE IP address and the IP flow ID.

Step S103: In response to the Rx Authentication Request/Npcf_PolicyAuthorization_Create service operation, PCRF/PCF node configures PCC rules to map the APP ID into a specific QoS level and sends to PCEF/SMF node a Reauthentication Request/Npcf_SMPolicyControl_Notify including the App ID, UE IP and IP flow.

Step S104: When using the pre-paid service, data volume consumed by UE is counted by PCEF (4G) or UPF (5G) node.

Step S105: PCEF/SMF node sends to PCRF/PCF node a Credit Control Request/Npcf_PolicySession_Update to report data volume consumed.

Step S106: PCRF/PCF node determines whether a user subscribing to the pre-paid service has fulfilled the quota (e.g., 10 Gb) on the basis of the Credit Control Request from PCEF/SMFnode.

Since the event that the user has fulfilled the quota is unknown for AF node, the QoS level for the user cannot be adjusted in time.

### SUMMARY OF THE INVENTION

It is desirable to enable AF to make an appropriate response when a subscriber has run out resources. For example, the response may include notifying the subscriber of subscribing to the resources and/or downgrading the QoS level for him.

In the above procedure as described with reference to FIG. 1, AF node needs to send a QoS request for each and every user. Since very often most subscribers are applicable to the same QoS control policy (e.g., the same QoS level is applied to any IP flow from a large amount of UEs towards any destination IP), it is inefficient to separately send the request. Moreover, under the standard procedure, PCRF/PCF node identifies a data connection (IP connectivity, or PDN connection in EPC, or PDU session in based on the IP address of each UE. Thus, AF node shall know in advance the IP address allocated to the UE so that the QoS request can be addressed to SCEF/NEF node and PCRF/PCF node.

The present disclosure describes efficient solutions to handle the above issues. In one or more embodiments of the present disclosure, by means of exposing an existing Charging Application Event to AF (e.g., Out_of_Credit), AF node can subscribe to this event when designating a QoS level to a session/IP flow in a QoS request. Moreover, in the QoS request sent to SCEF/NEF node, it can specify that the QoS level and the event as subscribed are applied to all UEs managed by PCRF/PCF node, regardless of IP addresses of the UEs, and destination IP address(es) (e.g. Netflix, Facebook, etc.). Alternatively, a notification sent to AF node can include a UE IP address and/or a UE ID (UE identity or GPSI, e.g. MSISDN, External ID) to indicate the UE or the user that has run out his resources quota.

According to one aspect, a method for providing a pre-paid service in a cellular communication network comprises the following steps carried out at a first node:
sending to a second node a request for subscribing to an event where resources for one of a group of subscribers have run out; and
in response to a message on occurrence of the event from the second node, sending to a terminal device using the resources a notification that the resources have run out,
wherein the first node is a node for application function (AF), and the second node is a node for exposing network capabilities and events.

According to another aspect, an apparatus for providing a pre-paid service in a cellular communication network comprises:
a storage device configured to store a computer program comprising computer instructions; and
a processor coupled to the storage device and configured to execute the computer instructions to:
send to a node for exposing network capabilities and events a request for subscribing to an event where resources for one of a group of subscribers have run out; and
in response to a message on occurrence of the event from the node for exposing network capabilities and events, sending to a terminal device using the resources a notification that the resources have run out.

According to still another aspect, a method for providing a pre-paid service in a cellular communication network comprises the following steps carried out at a first node:
receiving from a second node a request for subscribing to an event
where resources for one of a group of subscribers have run out, the group of subscribers being managed by a third node; and
in response to reporting occurrence of the event by the third node, sending to the second node a message indicating the occurrence of the event and a terminal device using the resources,
wherein the first node is a node for exposing network capabilities and events, the second node is a node for application function (AF), and the third node is a node for PCRF or PCF.

According to still another aspect, an apparatus for providing a pre-paid service in a cellular communication network comprises:
a storage device configured to store a computer program comprising computer instructions; and
a processor coupled to the storage device and configured to execute the computer instructions to:
receive from a node for AF a request for subscribing to an event
where resources for one of a group of subscribers have run out, the group of subscribers being managed by a node for PCRF or PCF; and
in response to reporting occurrence of the event by the node for PCRF or PCF, sending to the node for AF a message indicating the occurrence of the event and a terminal device using the resources.

According to still another aspect, a method for providing a pre-paid service in a cellular communication network comprises the following steps carried out at a first node:
sending to a second node a request for subscribing to an event where resources for one of a group of subscribers have run out, the group of subscribers being managed by the first node;
in response to reporting occurrence of the event by the second node, sending to a third node a message indicating the occurrence of the event and a terminal device using the resources,
wherein the first node is a node for PCRF (4G) or PCF (5G), the second node is a node for Policy and Charging Enforcement Function (PCEF) for 4G or the Session Management Function (SMF) for 5G, and the third node is a node for exposing network capabilities and events.

According to still another aspect, an apparatus for providing a pre-paid service in a cellular communication network comprises:
a storage device configured to store a computer program comprising computer instructions; and
a processor coupled to the storage device and configured to execute the computer instructions to:
send to a node for PCEF/SMF a request for subscribing to an event where resources for one of a group of subscribers have run out, the group of subscribers being managed by the apparatus; and
in response to reporting occurrence of the event by the node for PCEF, sending to a node for exposing network capabilities and events a message indicating the occurrence of the event and a terminal device using the resources.

In one or more embodiments of the present disclosure, since no IP address is required for AF to indicate a IP flow to which a QoS policy is applied, it allows an application to declare the QoS policy for all subscribers (or a group of subscribers) without the knowledge on the IP address(es) allocated to the users. Additionally, critical information, e.g., the event of out of credit, is available for taking QoS control for a specific subscriber (or all subscribers) by AF node if declaring the notification of the event in a QoS request.

### BRIEF DESCRIPTION OF THE DRAWINGS

The foregoing and other objects, features, and advantages of the disclosure would be apparent from the following more particular description of preferred embodiments as illustrated in the accompanying drawings in which:

FIG. 1 schematically illustrates a typical QoS control procedure in a scenario where a pre-paid service is provided by an AF.

FIG. 2 schematically illustrates a flowchart of a method for providing a pre-paid service in a cellular communication network according to one exemplary embodiment of the present disclosure.

FIG. 3 is a block diagram illustrating an apparatus for providing a pre-paid service in a cellular communication network according to another exemplary embodiment of the present disclosure.

FIG. 4 schematically illustrates a flowchart of a method for providing a pre-paid service in a cellular communication network according to one exemplary embodiment of the present disclosure.

FIG. 5 is a block diagram illustrating an apparatus for providing a pre-paid service in a cellular communication network according to another exemplary embodiment of the present disclosure.

FIG. 6 schematically illustrates a flowchart of a method for providing a pre-paid service in a cellular communication network according to one exemplary embodiment of the present disclosure.

FIG. 7 is a block diagram illustrating an apparatus for providing a pre-paid service in a cellular communication network according to another exemplary embodiment of the present disclosure.

FIG. 8 schematically illustrates a QoS control procedure in a scenario where a pre-paid service is provided by an AF according to another exemplary embodiment of the present disclosure.

FIG. 9 schematically illustrates a QoS control procedure in a scenario where a pre-paid service is provided by an AF according to another exemplary embodiment of the present disclosure.

FIG. 10 schematically illustrates a QoS control procedure in a scenario where a pre-paid service is provided by an AF according to another exemplary embodiment of the present disclosure.

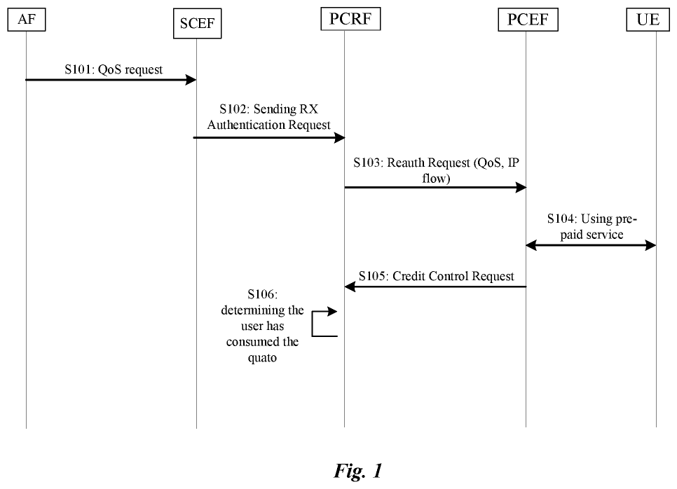

### DETAILED DESCRIPTION

The disclosure can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the disclosure may take, may be referred to as techniques. In general, the order of the steps of disclosed processes may be altered within the scope of the disclosure. Unless stated otherwise, a component such as a processor or a memory described as being configured to perform a task may be implemented as a general component that is temporarily configured to perform the task at a given time or a specific component that is manufactured to perform the task. As used herein, the term “processor” refers to one or more devices, circuits, and/or processing cores configured to process data, such as computer program instructions.

A detailed description of one or more embodiments of the disclosure is provided below along with accompanying figures that illustrate the principles of the disclosure. The disclosure is described in connection with such embodiments, but the disclosure is not limited to any embodiment. The scope of the disclosure is limited only by the claims and the disclosure encompasses numerous alternatives, modifications and equivalents.

Numerous specific details are set forth in the following description in order to provide a thorough understanding of the disclosure. These details are provided for the purpose of example and the disclosure may be practiced according to the claims without some or all of these specific details. For the purpose of clarity, technical material that is known in the technical fields related to the disclosure has not been described in detail so that the disclosure is not unnecessarily obscured.

As used herein, the term “terminal device” may be referred to as, for example, device, access terminal, user equipment (UE), mobile station, mobile unit, subscriber station, or the like. It may refer to any end device that can access a wireless communication network and receive services therefrom. By way of example and not limitation, the terminal device may include a portable computer, an image capture terminal device such as a digital camera, a gaming terminal device, a music storage and playback appliance, a mobile phone, a cellular phone, a smart phone, a tablet, a wearable device, a personal digital assistant (PDA), or the like.

As used herein, the term “Exposure Function (EF)” refers to a functional entity for exposing network capabilities and events detected, e.g., by other network functions. The non-exclusive examples of the EF include Service Capability Exposure Function (SCEF) as defined under 3GPP TS23.682 or Network Exposure Function (NEF) as defined under 3GPP TS23.502. Both of these 3GPP Specifications are incorporated herein by reference in its entirety.

In one or more embodiments of the present disclosure, by exposing a charging event, e.g., Out_of_Credit, to AFs via SCEF in EPC or NEF in 5GC, AFs can take some actions, e.g. downgrading the QoS level and pushing a notification on subscription to a relevant UE. Moreover, it allows AFs to subscribe to the charging event without indicating UE information or for all UEs in the QoS request. Furthermore, by centralizing all subscriptions/notifications to the charging event via SCEF/NEF, it makes the network operator possible to hide the 3GPP network topology to AFs, and thus AFs will not be impacted when the topology changes (e.g. a new PCRF/PCF instance is added to the network).

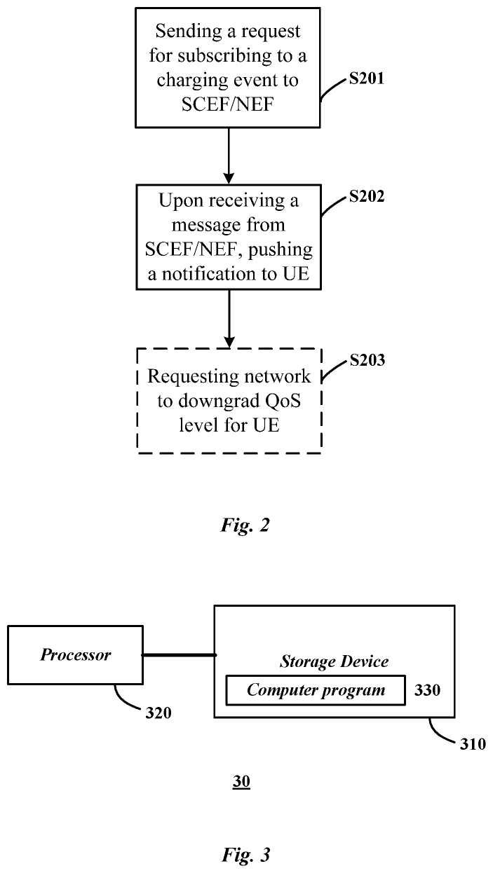

FIG. 2 schematically illustrates a flowchart of a method for providing a pre-paid service in a cellular communication network according to one exemplary embodiment of the present disclosure. For illustrative purpose, it assumes the method steps as shown in FIG. 2 are carried out at an AF node.

With reference to FIG. 2, at step S201, an AF node sends a request for subscribing to a charging event to a SCEF/NEF node, and thus the AF node will be notified of the occurrence of the event by SCEF/NEF node. As an example, if resources for one of a group of subscribers have run out, it determines that the charging event occurs. The resources herein can be measured in at least one item selected from a group consisting of storage volume, bandwidth, and time length.

Then, at step S202, in response to a message on occurrence of the event from the SCEF/NEF node, the AF node sending to a terminal device using the resources a notification that the resources have run out. As a response, the terminal device may take one or more actions, e.g., refilling the quota, changing the subscription terms and the like.

Alternatively, the request is a QoS request during an AF session, which includes: 1) an IP address indicator for defining all of the subscribers managed by a PCRF node or a PCF node as the group of subscribers; 2) an IP domain for defining a scope of IP flows; and 3) an event indicator for enabling the second node to notify the AF node of the event.

Alternatively, the request is an event exposure subscription request including: 1) an IP address indicator for defining all of the subscribers managed by the PCRF or PCF node as the group of subscribers; and 2) an event indicator for enabling the second node to notify the AF node of the event. The event exposure subscription request may further include an indicator for requiring an IP address of the terminal device in the message from the SCEF/NEF node.

Optionally, the process proceeds to step S203 where the AF node sends to the SCEF/NEF node another QoS request for downgrading the QoS level associated with the terminal device or subscriber as indicated in the message so that the PCRF or PCFnode will change the QoS level for the terminal device or subscriber as indicated.

FIG. 3 is a block diagram illustrating an apparatus for providing a pre-paid service in a cellular communication network according to another exemplary embodiment of the present disclosure.

With reference to FIG. 3, the apparatus 30 comprises a storage device 310 and a processor 320 coupled to the storage device 310. The storage device 310 is configured to store a computer program 330 comprising computer instructions. The processor 320 is configured to execute the computer instructions to perform some or all of the method steps as shown in FIG. 2.

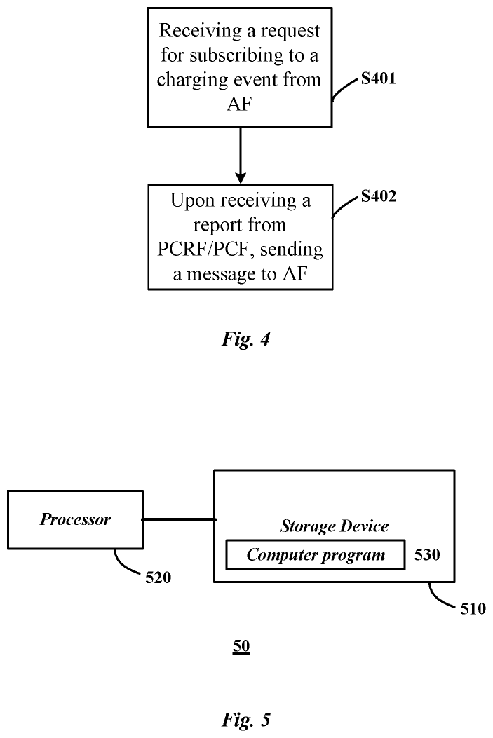

FIG. 4 schematically illustrates a flowchart of a method for providing a pre-paid service in a cellular communication network according to one exemplary embodiment of the present disclosure. For illustrative purpose, it assumes the method steps as shown in FIG. 4 are carried out at a SCEF/NEF node.

With reference to FIG. 4, at step S401, a SCEF/NEF node receives a request for subscribing to a charging event from an AF node. As an example, if resources for anyone of a group of subscribers managed by a PCRF/PCF node have run out, it determines that the charging event occurs. With this event subscription, the SCEF/NEF node will notify the AF node of the occurrence of the event.

Then, at step S402, in response to a report from the PCRF/PCF node that the charging event occurs, the SCEF/NEF node sends to the AF node a message indicating the occurrence of the event and a terminal device using the resources.

Alternatively, the request from the AF node is a QoS request during an AF session, which includes: 1) an IP address indicator for defining all of the subscribers managed by a PCRF node or a PCF node as the group of subscribers; 2) an IP domain for defining a scope of IP flows; and 3) an event indicator for enabling the second node to notify the AF node of the event.

Alternatively, the message is a HTTP notification including a terminal device ID for identifying the terminal device using the resources, an IP address for the terminal device using the resources and a flag indicating the occurrence of the event. The HTTP notification may further include an IP flow ID or a SDF flow ID for identifying the flows associated with the terminal device using the resources.

Alternatively, the request is an event exposure subscription request including: 1) an IP address indicator for defining all of the subscribers managed by the PCRF or PCF node as the group of subscribers; and 2) an event indicator for enabling the second node to notify the AF node of the event. The event exposure subscription request may further include an indicator for requiring an IP address of the terminal device in the message from the SCEF/NEF node.

Alternatively, the message is an event exposure notification including a terminal device ID for identifying the terminal device using the resources, an IP address for the terminal device using the resources and a flag indicating the occurrence of the event. The event exposure notification may further include an IP flow ID or a SDF flow ID for identifying the flows associated with the terminal device using the resources.

FIG. 5 is a block diagram illustrating an apparatus for providing a pre-paid service in a cellular communication network according to another exemplary embodiment of the present disclosure.

With reference to FIG. 5, the apparatus 50 comprises a storage device 510 and a processor 520 coupled to the storage device 510. The storage device 510 is configured to store a computer program 530 comprising computer instructions. The processor 520 is configured to execute the computer instructions to perform some or all of the method steps as shown in FIG. 4.

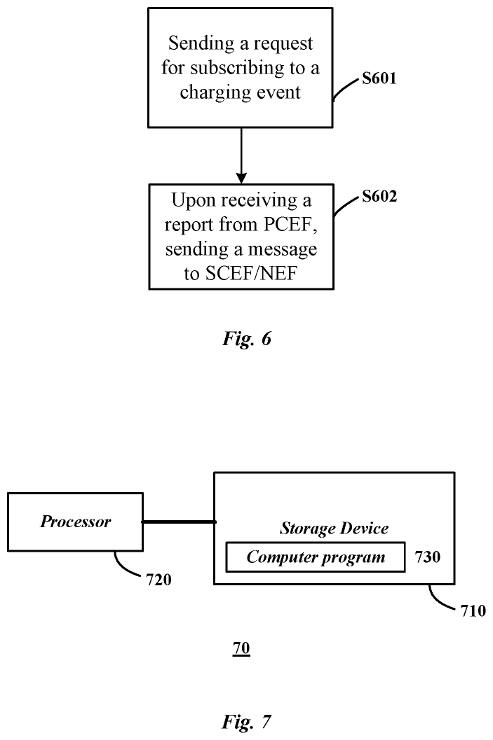

FIG. 6 schematically illustrates a flowchart of a method for providing a pre-paid service in a cellular communication network according to one exemplary embodiment of the present disclosure. For illustrative purpose, it assumes the method steps as shown in FIG. 6 are carried out at a PCRF/PCF node.

With reference to FIG. 6, at step S601, a PCRF/PCF node sends to a PCEF node (or SMF/UPF Network Functions in the 5G network) a request for subscribing to an event where resources for one of a group of subscribers managed by the PCRF/PCF node have run out.

Then, at step S602, in response to a report from the PCEF node (or SMF/UPF Network Functions in the 5G network) that the charging event occurs, the PCRF/PCF node sends to the SCEF/NEF node a message indicating the occurrence of the event and a terminal device using the resources.

FIG. 7 is a block diagram illustrating an apparatus for providing a pre-paid service in a cellular communication network according to another exemplary embodiment of the present disclosure.

With reference to FIG. 7, the apparatus 70 comprises a storage device 710 and a processor 720 coupled to the storage device 710. The storage device 710 is configured to store a computer program 730 comprising computer instructions. The processor 720 is configured to execute the computer instructions to perform some or all of the method steps as shown in FIG. 6.

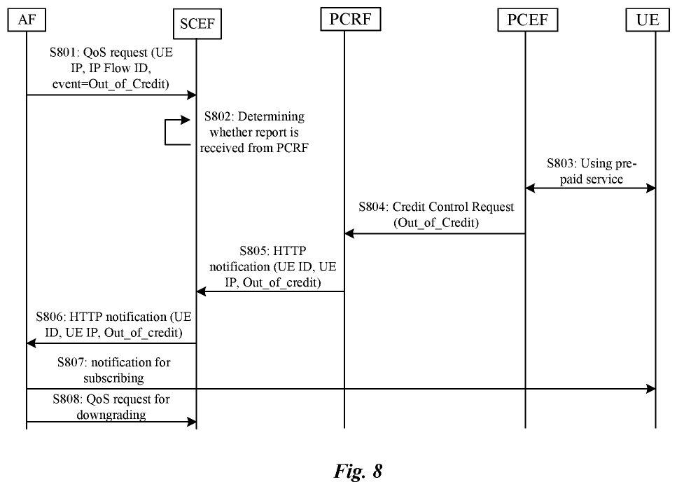

FIG. 8 schematically illustrates a QoS control procedure in a scenario where a pre-paid service is provided by an AF according to another exemplary embodiment of the present disclosure. It shall be noted that although the QoS control procedure as shown in FIG. 8 is described in 4G scenarios, it is also applicable to 5G scenarios by making some modifications. For example, the modification include but are not limited to replacing SCEF node by NEF node, and replacing PCRF node by PCF NETWORK FUNCTION node.

As shown in FIG. 8, the procedure comprises the following steps:

Step S801: AF node initiates an AF session by sending a QoS request including a UE IP address, e.g., “0.0.0.0”, an IP flow ID, e.g., “All_Flows”, and an event indicator, e.g., “Out_of_Credit”. The address “0.0.0.0” herein indicates the subscription to the event as identified by the event indicator is applicable to all of the users managed by PCRF node, the IP flow ID indicates an IP domain with the scope of the IP flows, and “All_Flows” herein means the subscription is applicable to all of the destination IP addresses, and the event indicator indicates the type of event for subscription.

Step S802: Upon reception of the QoS request, SCEF node assumes PCRF node has a pre-configured QoS policy to notify SCEF of the “Out_of_Credit” event and thus determine whether a report on the “Out_of_Credit” event is received from PCRF node.

Step S803: When using the pre-paid service, data volume and time consumed by UE is counted by PCEF node (or SMF/UPF Network Functions in the 5G network).

Step S804: PCEF node (or SMF/UPF Network Functions in the 5G network) determines that a user subscribing to the pre-paid service has fulfilled the quota and sends to PCRF node a Credit Control Request indicating the occurrence of the “Out_of_Credit” event.

Step S805: PCRF node creates a HTTP notification on the basis of the Credit Control Request from PCEF node (or SMF/UPF Network Functions in the 5G network) and sends the HTTP notification to SCEF. In the HTTP notification, an IP address and ID for the terminal device associated the “Out_of_Credit” event are included.

Step S806: In response to the notification from PCRF node, SCEF node creates a HTTP notification including an IP address and ID for the terminal device associated the “Out_of_Credit” event and a flag indicating the occurrence of the event are contained therein, and sends the created HTTP notification to AF node.

Step S807: In response to the notification from SCEF node, AF node creates a notification that the resources, e.g., data volume, have run out, and pushes the notification to UE.

Step S808: AF node sends to SCEF node a QoS request for downgrading a QoS level for UE.

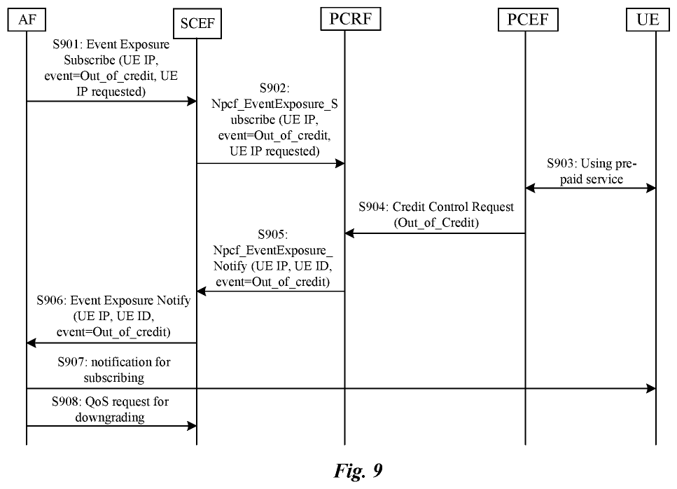

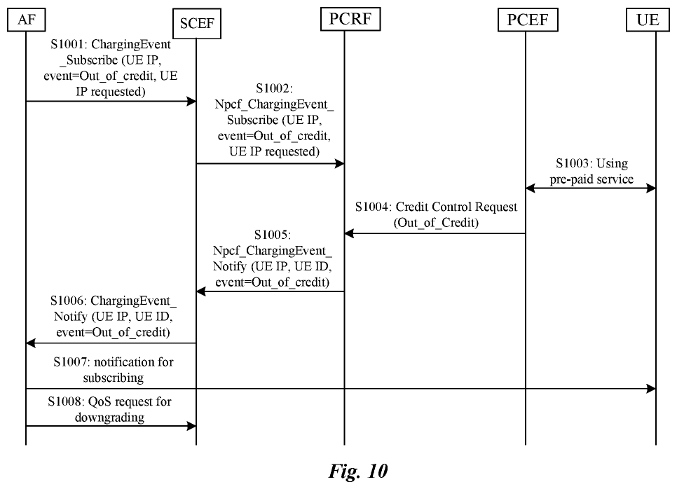

FIG. 9 schematically illustrates a QoS control procedure in a scenario where a pre-paid service is provided by an AF according to another exemplary embodiment of the present disclosure. It shall be noted that although the QoS control procedure as shown in FIG. 9 is described in 4G scenarios, it is also applicable to 5G scenarios by making some modifications. For example, the modification include but are not limited to replacing SCEF node by NEF node, and replacing PCRF node by PCF NETWORK FUNCTION node.

As shown in FIG. 9, the procedure comprises the following steps:

Step S901: AF node sends to SCEF node an event exposure subscribe request including a UE IP address, e.g., “0.0.0.0”, an event indicator, e.g., “Out_of_Credit”, and an indicator for requiring the IP address of the terminal device involved in the event as identified by the event indicator shall be included in a notification on the occurrence of the event. The address “0.0.0.0” herein indicates the subscription to the event as identified by the event indicator is applicable all of the users managed by PCRF node, and the event indicator indicates the type of event for subscription. In the present embodiment, the event exposure subscribe request may be a Event Exposure Subscribe message.

Step S902: In response to the event exposure subscribe request, SCEF node sends an event subscribe request indicating it applies to all UEs (identification of any UE is accomplished by omitting “groupId” attribute) an event indicator, e.g., “Out_of_Credit” and an indicator for requiring the IP address of the terminal device, to PCRF node. In the present embodiment, the event subscribe request may be a Npcf_EventExposure_Subscribe message as defined in 3GPP TS 29.523.

Step S903: When using the pre-paid service, data volume and time consumed by UE is counted by PCEF node (or SMF/UPF Network Functions in the 5G network).

Step S904: PCEF node (or SMF/UPF Network Functions in the 5G network) determines that a user subscribing to the pre-paid service has fulfilled the quota and sends to PCRF node a Credit Control Request indicating the occurrence of the “Out_of_Credit” event.

Step 905: PCRF node creates an event notification on the basis of the Credit Control Request from PCEF node (or SMF/UPF Network Functions in the 5G network) and sends the notification to SCEF node. The event notification includes an IP address and ID for the terminal device associated the “Out_of_Credit” event. In the present embodiment, the event notification may be a Npcf_EventExposure_Notify message as defined in 3GPP TS 29.523.

Step S906: In response to the notification from PCRF node, SCEF node creates an event exposure notification including an IP address and ID for the terminal device associated the “Out_of_Credit” event and a flag indicating the occurrence of the event, and sends the created message to AF node. In the present embodiment, the event exposure notification may be a Event Exposure Notify message.

Step S907: In response to the notification from SCEF node, AF node creates a notification that the resources, e.g., data volume, have run out, and pushes the notification to UE.

Step S908: AF node sends to SCEF node a QoS request for downgrading a QoS level for UE.

FIG. 10 schematically illustrates a QoS control procedure in a scenario where a pre-paid service is provided by an AF according to another exemplary embodiment of the present disclosure. It shall be noted that although the QoS control procedure as shown in FIG. 9 is described in 4G scenarios, it is also applicable to 5G scenarios by making some modifications. For example, the modification include but are not limited to replacing SCEF node by NEF node, and replacing PCRF node by PCF NETWORK FUNCTION node.

As shown in FIG. 10, the procedure comprises the following steps:

Step S1001: AF node sends to SCEF node an event exposure subscribe request including a UE IP address, e.g., “0.0.0.0”, an event indicator, e.g., “Out_of_Credit”, and an indicator for requiring the IP address of the terminal device involved in the event as identified by the event indicator shall be included in a notification on the occurrence of the event. The address “0.0.0.0” herein indicates the subscription to the event as identified by the event indicator is applicable all of the users managed by PCRF node, and the event indicator indicates the type of event for subscription. In the present embodiment, the event exposure subscribe request may be a ChargingEvent_Subscribe message, which may be defined in future 3GPP TS.

Step S1002: In response to the event exposure subscribe request, SCEF node sends an event subscribe request including a UE IP address, e.g., “0.0.0.0” or alternatively an “Any UE” indicator, an event indicator, e.g., “Out_of_Credit” and an indicator for requiring the IP address of the terminal device, to PCRF node. In the present embodiment, the event subscribe request may be a Npcf_ChargingEvent_Subscribe message, which may be defined in future 3GPP TS.

Step S1003: When using the pre-paid service, data volume and time consumed by UE is counted by PCEF node (or SMF/UPF Network Functions in the 5G network).

Step S1004: PCEF node (or SMF/UPF Network Functions in the network) determines that a user subscribing to the pre-paid service has fulfilled the quota and sends to PCRF node a Credit Control Request indicating the occurrence of the “Out_of_Credit” event.

Step 1005: PCRF node creates an event notification on the basis of the Credit Control Request from PCEF node (or SMF/UPF Network Functions in the 5G network) and sends the notification to SCEF node. The event notification includes an IP address and ID for the terminal device associated the “Out_of_Credit” event. In the present embodiment, the event notification may be a Npcf_ChargingEvent_Notify message, which may be defined in future 3GPP TS.

Step S1006: In response to the notification from PCRF node, SCEF node creates an event exposure notification including an IP address and ID for the terminal device associated the “Out_of_Credit” event and a flag indicating the occurrence of the event, and sends the created message to AF node. In the present embodiment, the event exposure Notification may be a ChargingEvent_Notify message, which may be defined in future 3GPP TS.

Step S1007: In response to the notification from SCEF node, AF node creates a notification for subscribing the resource, e.g., data volume, and pushes the notification to UE.

Step S1008: AF node sends to SCEF node a QoS request for downgrading a QoS level for UE.

It should be noted that the aforesaid embodiments are illustrative of this disclosure instead of restricting this disclosure, substitute embodiments may be designed by those skilled in the art without departing from the scope of the claims enclosed. The wordings such as “include”, “including”, “comprise” and “comprising” do not exclude elements or steps which are present but not listed in the description and the claims. It also shall be noted that as used herein and in the appended claims, the singular forms “a”, “an”, and “the” include plural referents unless the context clearly dictates otherwise. This disclosure can be achieved by means of hardware including several different elements or by means of a suitably programmed computer. In the unit claims that list several means, several ones among these means can be specifically embodied in the same hardware item. The use of such words as first, second, third does not represent any order, which can be simply explained as names. While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1. A method for providing a pre-paid service in a cellular communication network, the method comprising, at a first node:
sending to a second node a request for subscribing to an event where resources for one of a group of subscribers have run out;
in response to a message on occurrence of the event from the second node, sending to a terminal device using the resources a notification that the resources have run out; and
the first node being a node for application function (AF), and the second node is a node for exposing network capabilities and events.

2. The method according to claim 1, further comprising:
sending to the second node a QoS request for downgrading a QoS level for the one of a group of subscribers.

3. The method according to claim 1, wherein the resources are measured in at least one item selected from a group consisting of storage volume, bandwidth, and time length.

4. The method according to claim 1, wherein the request is a QoS request during an AF session, and the QoS request includes an IP address indicator for defining all of the subscribers managed by a third node as the group of subscribers, an IP domain for defining a scope of IP flows and an event indicator for enabling the second node to notify the first node of the event, the third node is a node for Policy and Charging Rules Function (PCRF) or Policy Control Function (PCF).

5. The method according to claim 1, wherein the request is an event exposure subscription request including an IP address indicator for defining all of the subscribers managed by a third node as the group of subscribers and an event indicator for enabling the second node to notify the first node of the event, the third node is a node for Policy and Charging Rules Function (PCRF) or Policy Control Function (PCF).

6. The method according to claim 5, wherein the event exposure subscription request further includes an indicator for requiring an IP address of the terminal device in the message from the second node.

7. The method according to claim 1, wherein the second node is a node for Service Capability Exposure function (SCEF) or Network Exposure Function (NEF).

8.-13. (canceled)

14. A method for providing a pre-paid service in a cellular communication network, the method comprising, at a first node:
receiving from a second node a request for subscribing to an event where resources for one of a group of subscribers have run out, the group of subscribers being managed by a third node;
in response to reporting occurrence of the event by the third node, sending to the second node a message indicating the occurrence of the event and a terminal device using the resources; and
the first node being a node for exposing network capabilities and events, the second node is a node for application function (AF), and the third node is a node for Policy and Charging Rules Function (PCRF) or Policy Control Function (PCF).

15. The method according to claim 14, wherein the resources are measured in at least one item selected from a group consisting of storage volume, bandwidth, and time length.

16. The method according to claim 14, wherein the request is a QoS request during an AF session, and the QoS request includes an IP address indicator for defining all of the subscribers managed by the third node as the group of subscribers, an IP domain for defining a scope of IP flows and an event indicator for enabling the first node to notify the second node of the event.

17. The method according to claim 16, wherein the message is a HTTP notification including a terminal device ID for identifying the terminal device using the resources, an IP address for the terminal device using the resources and a flag indicating the occurrence of the event.

18. The method according to claim 14, wherein the request is an event exposure subscription request including an IP address indicator for defining all of the subscribers managed by the third node as the group of subscribers and an event indicator for enabling the first node to notify the second node of the event.

19. The method according to claim 18, wherein the event exposure subscription request further includes an indicator for requiring an IP address of the terminal device in the message from the first node.

20. The method according to claim 19, wherein the message is an event exposure notification including a terminal device ID for identifying the terminal device using the resources, an IP address for the terminal device using the resources and a flag indicating the occurrence of the event.

21. The method according to claim 10, wherein the first node is a node for Service Capability Exposure function (SCEF) or Network Exposure Function (NEF).

22.-28. (canceled)

29. A method for providing a pre-paid service in a cellular communication network, the method comprising, at a first node:
sending to a second node a request for subscribing to an event where resources for one of a group of subscribers have run out, the group of subscribers being managed by the first node;
in response to reporting occurrence of the event by the second node, sending to a third node a message indicating the occurrence of the event and a terminal device using the resources; and
the first node being a node for PCRF or PCF, the second node is a node for Policy and Charging Enforcement Function (PCEF) or Session Management Function (SMF), and the third node is a node for exposing network capabilities and events.

30. The method according to claim 29, wherein the resources are measured in at least one item selected from a group consisting of storage volume, bandwidth, and time length.

31. The method according to claim 29, wherein the group of subscribers includes all of the subscribers managed by the first node.

32. The method according to claim 29, wherein the message is a HTTP notification including a terminal device ID for identifying the terminal device using the resources, an IP address for the terminal device using the resources and a flag indicating the occurrence of the event.

33. The method according to claim 29, wherein the message is an event exposure notification including a terminal device ID for identifying the terminal device using the resources, an IP address for the terminal device using the resources and a flag indicating the occurrence of the event.

34. The method according to claim 29, wherein the third node is a node for Service Capability Exposure function (SCEF) or Network Exposure Function (NEF).

35.-39. (canceled)
